(19) United States
(12) Patent Application Publication
(10) Pub. No.: US 2006/0061329 A1
(43) Pub. Date: Mar. 23, 2006

(54) Method and apparatus for a power line communication (PLC) network

(75) Inventor: Thomas Patrick Dawson, Escondido, CA (US)

Correspondence Address: CROWELL & MORING LLP;INTELLECTUAL PROPERTY GROUP, P.O. BOX 14300, WASHINGTON, DC, 20044-4300, US

(73) Assignees: Sony Corporation; Sony Electronics Inc.

(21) Appl. No.: 11/034,401

(22) Filed: Jan. 11, 2005

Related U.S. Application Data
(60) Provisional application No. 60/610,731, filed on Sep. 17, 2004.

(51) Int. Cl. H02J 7/00

(52) U.S. Cl. 320/115

(57) ABSTRACT

Method and apparatus for a power line communication (PLC) network. One aspect of the invention is to use the DC power lines within a vehicle to network a plurality of electronic devices within the vehicle. In another embodiment, a vehicle's DC power lines may be used to both power an electronic user device, as well as provide network connectivity between two or more electronic user devices. In one embodiment, network access is accomplished through use of connectors (e.g., cigarette lighter sockets) which are already standard in vehicles.

### CROSS REFERENCE TO RELATED APPLICATION

This application claims priority to U.S. Provisional Patent Application Ser. No. 60/610,731 filed on Sep. 17, 2004.

### FIELD OF THE INVENTION

The present invention relates generally to digital data communications and networking and in particular to using direct current (DC) power lines to achieve said communications and networking between electronic devices.

### BACKGROUND

While there have been significant advances in providing home and office networking, little has been done to improve the network connectivity options within vehicles. Despite the fact that commute times are only on the rise, there remains few options available for vehicle passengers to share information over a standardized and convenient network.

Additionally, many vehicles include onboard navigation systems. Vehicles also contain GPS transceivers, DVD players, and other onboard computer systems from which potentially useful data could be shared among the vehicle's occupants. However, there is no standardized interface for accessing such data.

While it may be possible to retro-fit a vehicle with networking hardware and software to provide local area network (LAN) functionality, such a solution is both expensive and still lacking in a standardized network interface. Thus, what is needed is a method and apparatus for introducing networking functionality into vehicles using network interfaces which are standard vehicle hardware. Additionally what is needed is a method and apparatus that networks the various computer systems within an automobile, such as the main engine computer, ABS system, etc in order to eliminate bus wiring and cables.

### SUMMARY

Methods and apparatus for an in-vehicle power line communication network. In one embodiment, a plurality of devices to be networked is connected to a power converter unit, one for each device; said converters provide network connectivity and power, via separate cables for each. In another embodiment, said power converters provide each device with both power and network connectivity through the same cable. In yet another embodiment, there is a plurality of cables per each power converter, each cable providing both power and network connectivity.

Other aspects, features, and techniques of the invention will be apparent to one skilled in the relevant art in view of the following detailed description of the invention.

### BRIEF DESCRIPTION OF THE DRAWINGS

FIG. 1 is one embodiment of a DC power line network in accordance with the. principles of the present invention;

FIG. 2 is a block diagram representation of one embodiment for performing digital network communications between a data source and a data destination, consistent with the principles of the invention; and

FIG. 3 is a schematic diagram of a DC power line converter usable to provide electronic user devices with both power and network, consistent with the implementation of the invention.

### DETAILED DESCRIPTION OF THE EXEMPLARY EMBODIMENTS

Methods and apparatus for providing vehicle networking functionality using standard vehicle hardware are disclosed herein. One aspect of the invention is to use the DC power lines within a vehicle to network a plurality of electronic devices within the vehicle. In another embodiment, a vehicle's DC power lines may be used to both power an electronic user device, as well as provide network connectivity between two or more electronic user devices.

Another aspect of the invention is to use a vehicle's cigarette lighter to power and provide network connectivity to electronic devices, such as laptop computers, PDAs, GPS transceivers, cellular telephones, etc. In one embodiment, this aspect is implemented using a vehicle's DC power line as an in-car network.

Many vehicles have cigarette lighters for use in the rear seats (e.g., minivans, SUVs, boats, planes, etc). Some, such as in mini-vans may have several such sockets positioned at various locations throughout the vehicle. These, as well as the one on the driver's console, make up an existing power line network that is available on all vehicles. As such, one aspect of the invention is to provide a digital network in the vehicle at no cost to the vehicle manufacturer by using its existing power line.

The goal of power line networking is to send both power and data across the same wire; the power drives a device, and the wire carries modified electrical pulses which stand for the data being carried. Data is specified using the ones and zeros of the binary number system employed by computers: a one value is represented by an electrical pulse; the absence of a pulse indicates a zero. Strings of pulses and absences thereof can be put into sequences to carry data across the wire. In the case of Alternating Current (AC) PLC, the amount of current (i.e., power) varies periodically and the frequency, and strength (or amplitude) of this current can be varied according to specific patterns as described above to carry data from sender to receiver using the very electricity used to power the device itself.

In one embodiment, the frequencies of periodically-varying signals used by the network may be filtered by the existing vehicle power system such as not to affect the operation of the vehicle. That is, if electrical pulses are emitted at a rate of, e.g., 150 pulses/second or lower (i.e., 150 Hz; 1 Hz (hertz) equals one pulse per second), most vehicles contain circuitry to block out such lower frequencies so the electrical pulses never enter the vehicle electrical system and thereby interfere with the operation of the vehicle.

Moreover, it may be necessarily to limit interferences caused by the vehicle's operation. In particular, the engine generates a periodic electrical signal (the “noise”) due to the fact that a car motor consists of wires which spin between the poles of a magnet; this is how alternating current is generated inside the wires. This current, however, shows up as a 50-60 Hz background signal which can distort any network communication signals riding on the power line in question. Thus, in one embodiment, this noise is removed using a so-called “high-pass filter.” Such a filter circuit may block periodic electrical signals with frequencies below, e.g., 500 Hz, from passing to other components and passes electrical signals with frequencies above this value, thereby reducing distortion of the network signal by the current generated by the vehicle engine operation.

In addition to a power-line network based in the vehicle power system itself, most vehicles today possess sophisticated onboard computer systems, including multiprocessors, hard-disk drives, CD drives, and network access. Accordingly, another aspect of the invention is to be able to access these onboard systems using an electronic user device via the via the power line network. In one embodiment, the electronic device may be able to access real-time performance data pertaining to the vehicle, and/or read/write data to/from the vehicle's onboard system, e.g., store music files for playback via the vehicle's audio system.

It should be mentioned that the system described above is not limited to applications solely in automobiles as many different types of vehicles provide cigarette-lighter style power connections, such as power boats, RVs and personal aircraft.

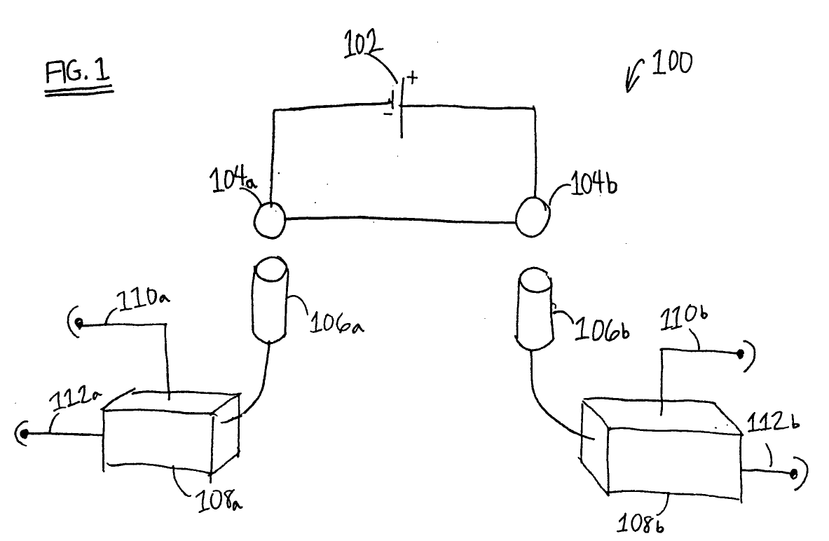

Referring now to the figures, FIG. 1 depicts one embodiment of a direct-current power line communication network system 100 for use in automobiles or other vehicles. In this embodiment, one or more batteries or other DC power sources 102 may be connected via power lines to the vehicle's cigarette-lighter-type sockets 104a and 104b. It should be noted that vehicles may possess as few as one or more than two of these sockets as is specified by the vehicle manufacturer. There are some embodiments and vehicle designs for which vehicle power may be accessed by sockets which are not standard cigarette-lighter-type sockets. To each socket 104a and 104b, connectors 106a and 106b link DC power converters 108a and 108b, respectively, to the circuit. In one embodiment, the converters 108a and 108b also provide the Power Line Communication (PLC) network connection to a connected electronic device (e.g., PDA, GPS transceiver, etc). In one embodiment, power is provided by the converter to said electronic device via the cables 110a and 110b, while network connectivity is provided to said electronic device via the cables 112a and 112b. In another embodiment, cables 110a and 112a (likewise, cables 110b and 112b) are the same, and the single cable provides both power and network connectivity to an electronic device. In yet another embodiment, cables 110a and 112a (likewise, cables 110b and 112b) are separate, but cable 110a (likewise, 110b) provides both power and network connectivity, and, in like fashion, cable 112a (likewise, 112b) also provides both power and network connectivity; in this mode, more than one electronic device may be connected to the same power converter unit.

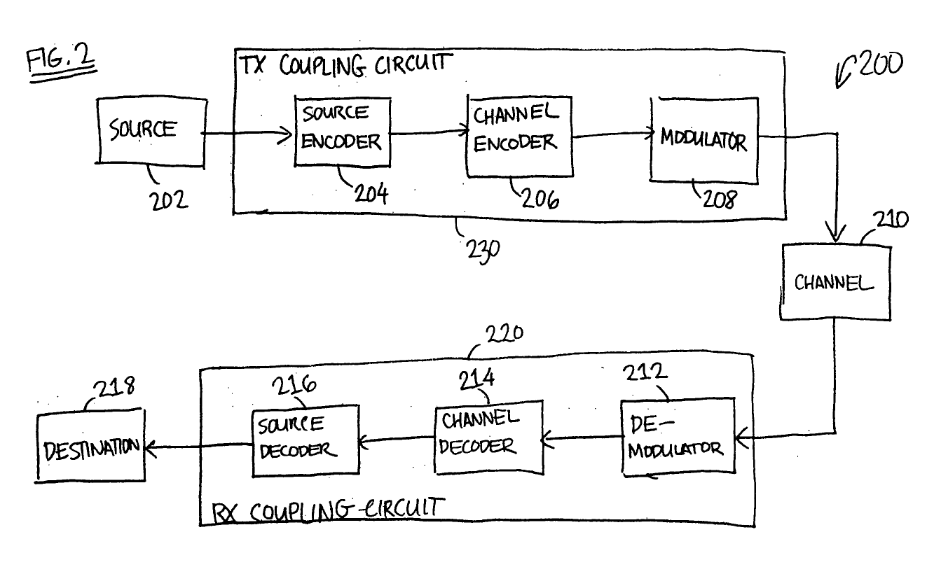

FIG. 2 depicts a simplified schematic diagram 200 of one embodiment of how data may be transmitted from a source 202 to a destination 218, consistent with the principles of the invention. Data travels between the source 202 and destination 218 by means of a communications channel 210, which may be a length of electrical cable, a power transmission line such as those employed by utility companies, copper wire such as that employed for the telephone infrastructure, fiber optic lines or satellite comlink. The source 202 of data to be transmitted sends the data to a device known as a Transmission (TX) coupling circuit 230, which in one embodiment contains a source encoder 204 to compress and/or re-format the source data as required for communications; a channel encoder 206 which prepares the data to be sent over the communications channel 210; and a modulator 208 to encode the data itself into the frequency, phase, or amplitude modulation of the output signal. The output of the TX coupling circuit 230 is then sent over the communications channel 210 to the Reception (RX) coupling circuit 220, which in one embodiment includes a demodulator 212 which detects and interprets the changes in phase, frequency, or amplitude of the signal as effected by the modulator 208 on the source end. The output of the demodulator 212 then is sent to the channel decoder 214 which converts the data from the channel-specific format into that understood by the destination receiver. Finally, a source decoder 216 translates the data from the format entered by the data source into that which the destination device 218 understands. FIG. 2 shows one embodiment, in a general context, of how digital communications may be accomplished consistent with the principles of the invention, and provides a basis for the following description of one embodiment of the DC power converters 108a and 108b of FIG. 1.

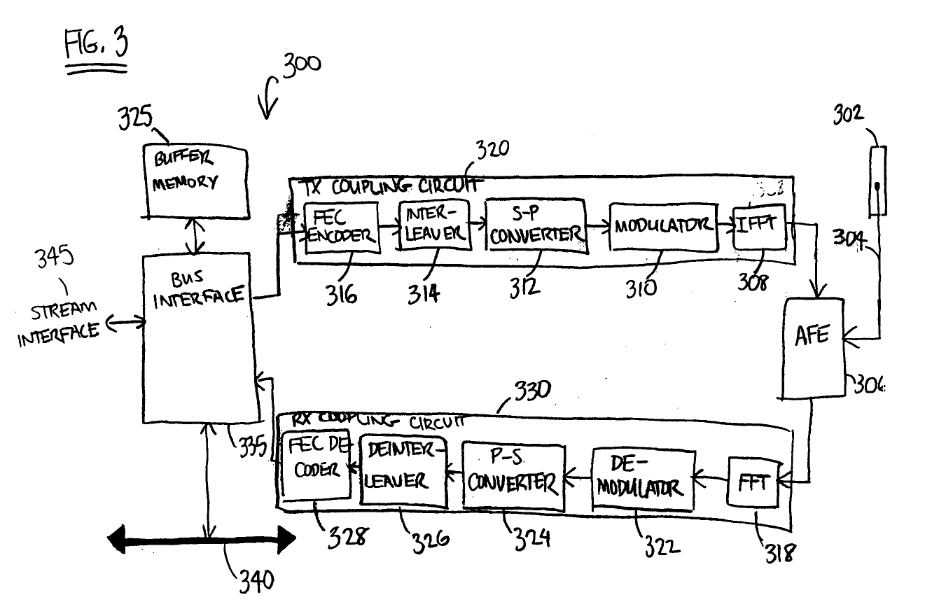

FIG. 3 depicts a more detailed embodiment of the converters 108a and 108b of FIG. 1. In one embodiment, DC power converter 300 may be used for providing power and network connectivity to an attached electronic device. In another embodiment, data may be sent using Orthogonal Frequency Division Multiplex (OFDW), which may be used for splitting a signal into several ‘sub-signals’. This helps protect against possible interference of one data signal with another. For example, if interference occurs, it would be possible to just switch to a new ‘sub-signal.’ OFDM may use many sub-carriers (i.e., more than 100) to protect against this so-called multi-path interference.

Data to be transmitted is received from the internal bus 340 by bus interface 335 and may optionally be stored in the buffer memory 325 temporarily. Alternatively, data from an audio codec (e.g., Audio Codec 2) may be received through the stream interface 345. Regardless of the data source (e.g., internal bus 340, buffer memory 325 or the stream interface 345), in the embodiment of FIG. 3, the data is sent on to the TX Coupling Circuit 320, which comprises the components responsible for sending data over the network (see, e.g., FIG. 2). When processing data signals, it is possible for errors to occur, either by two values getting switched with each other or getting shifted in place relative to other values. To circumvent this, an error-correction code may be added to the data in the Forward Error Correction (FEC) Encoder 316. Next, the output data is interleaved by the interleaver 314, and then Serial-Parallel converted by the S-P Converter 312. The parallel signals are modulated by the Modulator 310 and then may be sent to the Inverted Fast Fourier Transform (IFFT) block 308. In the IFFT 308, a carrier may be assigned to each input signal to overlay the DC power and all the signals are then inversely-Fast-Fourier-transformed. In one embodiment, the data is digital- analog converted in the IFFT 308 and outputted from the TX Coupling Circuit 320 to the Analog Front End (AFE) 306, whereupon the result is then sent over the DC power line 304 to the standard vehicle power plug 302. Note how the DC power line 304 and standard vehicle power plug 302, as well as the internal vehicle power circuitry, all serve as the communications channel for the digital communications employed by one or more embodiments of the invention.

The opposite process occurs upon the reception of data via the standard vehicle power plug 302, over the DC power line 304 and through the Analog Front End 306. In one embodiment, the data is high-pass-filtered first; this removes noise and interference from the electrical operation of the vehicle's engine. The high-pass filtering process may first set a ‘threshold frequency,’ where signals that have frequencies below the threshold are blocked, and those at or above the threshold are permitted to continue on to the next circuit component. Engine noise typically occurs with a frequency of approximately 50-60 Hz (or cycles per second). In one embodiment, electronic devices coupled to the vehicle's power circuitry via the DC power converter 300 involve electrical signals that possess frequencies of approximately 150-500 Hz. After the signal is filtered by Analog Front End 306, it is then converted from analog to digital format and sent for processing by the components of RX Coupling Circuit 330, whereupon the signal is fast-Fourier-transformed by FFT 318, demodulated by the Demodulator 322, converted from parallel to serial by P-S converter 324, deinterleaved by Deinterleaver 326, and then error-corrected by the Forward Error-Correction (FEC) decoder 328. The data is then outputted from the RX Coupling Circuit 330 and sent to Bus Interface 335. In one embodiment, the data may be temporarily stored in in Buffer Memory 325 before being sent to the internal bus 340 or the stream interface 345.

One aspect of the invention is that the power converter, in addition to providing network connectivity to connected electronic devices, also provides power to said device(s). Direct current (DC) flows and is present at all points in the circuit once the power connection is established with the vehicle power system via the plug 302 in FIG. 3. In one embodiment, the circuit 300 is tapped at some convenient point, the data signal is removed by a filter, and the remaining DC current present serves as the power connection for, e.g., charging a connected device. For devices which accept power and network signals over the same wire, e.g. in other exemplary embodiments, the power converter provides the power through the same interface as it does network connectivity.

What is claimed is:

1. A system comprising:
a first direct current (DC) power outlet coupled to a DC power source by a DC power line;
a first electronic device powered by a first DC power cell and having a first network port; and
a first adapter to connect said first electronic device to said first DC power outlet, wherein said first adapter is to,
provide a first electrical charge from said DC power source to said first DC power cell of said first electrical device, and
transfer data from said first network port over said DC power line.

2. The system of claim 1, wherein said first DC power outlet is a standard automobile cigarette lighter, and said DC power source is an automobile battery.

3. The system of claim 1, wherein said first electronic device is one of a portable computer, laptop computer, personal digital assistant, cellular telephone and smartphone.

4. The system of claim 1, wherein said first electrical charge is provided to said first DC power cell over said DC power line simultaneously with said data being transferred from said first network port over said DC power line.

5. The system of claim 1, further comprising:
a second DC power outlet coupled to said DC power source by said DC power line;
a second electronic device powered by a second DC power cell and having a second network port; and
a second adapter to connect said second electronic device to said second DC power outlet, wherein said second adapter is to,
provide a second electrical charge from said DC power source to said second DC power cell of said second electrical device, and
transfer data from said second network port to said first network port over said DC power line.

6. The system of claim 5, wherein said first and second DC power outlets are standard automobile cigarette lighters, said DC power source is an automobile battery.

7. The system of claim 5, wherein said first and second electronic devices are selected from the group consisting of portable computers, laptop computers, personal digital assistants, cellular telephones and smartphones.

8. The system of claim 5, wherein said first and second electronic devices establish a network connection over said DC power line using said first and second adapters.

9. The system of claim 5, wherein said second electronic device is a network accessory usable to transmit said data wirelessly to a remote server.

10. The system of claim 1, wherein said first electronic device receives said first electric charge and said data through said first network port.

11. A method comprising:
charging a first electronic device coupled to a first DC power outlet using a DC power source, wherein said first electronic device is coupled to said first DC power outlet by a first port, and said DC power source is coupled to said first DC power outlet by a DC power line;
transferring data from said first electronic device over said DC power line using a first adapter to connect said first electronic device to said first DC power outlet, wherein said first adapter is to,
provide a first electrical charge from said DC power source to said first DC power cell of said first electrical device, and
transfer data from said first network port over said DC power line.

12. The method of claim 11, wherein said first DC power outlet is a standard automobile cigarette lighter, and said DC power source is an automobile battery.

13. The method of claim 11, wherein said first electronic device is one of a portable computer, laptop computer, personal digital assistant, cellular telephone and smartphone.

14. The method of claim 11, wherein providing said first electrical charge comprises providing said first electrical charge to said first DC power cell over said DC power line simultaneously with said data being transferred from said first network port over said DC power line.

15. The method of claim 11, further comprising:
charging a second electronic device coupled to a second DC power outlet using said DC power source, wherein said second electronic device is coupled to said first DC power outlet by a second port, and said DC power source is coupled to said second DC power outlet by said DC power line; and
transferring data from said second electronic device over said DC power line using a second adapter to connect said second electronic device to said second DC power outlet, wherein said second adapter is to,
provide a second electrical charge from said DC power source to a second DC power cell of said second electrical device, and
transfer data from said second port to said first port over said DC power line.

16. The method of claim 15, wherein said first and second DC power sources are standard automobile cigarette lighters, said DC power source is an automobile battery.

17. The method of claim 15, wherein said first and second electronic devices are selected from the group consisting of portable computers, laptop computers, personal digital assistants, cellular telephones and smartphones.

18. The method of claim 15, further comprising establishing a network connection between said first and second electronic devices over said DC power line using said first and second adapters.

19. The method of claim 15, wherein said second electronic device is a network accessory usable to transmit said data wirelessly to a remote server.

20. The method of claim 15, wherein said first electronic device receives said first electric charge and said data through said first port.
